(19) United States
(12) Patent Application Publication
(10) Pub. No.: US 2026/0346056 A1
(43) Pub. Date: Nov. 5, 2026

(54) DESCENT CONTROL DEVICE

(71) Applicant: RAPID RAPPEL TECHNOLOGY AS, Stjørdal (NO)

(72) Inventor: Morten MONDAHL, Stjørdal (NO)

(73) Assignee: RAPID RAPPEL TECHNOLOGY AS, Stjørdal (NO)

(21) Appl. No.: 19/123,850

(22) PCT Filed: Oct. 12, 2023
(86) PCT No.: PCT/NO2023/060072

§ 371 Date: Apr. 24, 2025

(30) Foreign Application Priority Data
Oct. 31, 2022 (NO) 20221163

(51) Int. Cl. A62B 1/14

(52) U.S. Cl. CPC A62B 1/14

(57) ABSTRACT

The invention relates to a descent control device (100) comprising a housing (110), a moveable handle (120) and one or more adjustable members (130) protruding from the housing, wherein the housing (110) comprises:
an entrance (111) and an exit (112) for a rope,
a channel (140) for a rope between the entrance and the exit,
a rotatable brake element (150),
an internal path (160), and
a moveable brake element (170),
   and wherein
the moveable handle (120) is connected to the rotatable brake element (150),
the rotatable brake element (150) is adjustable to alter a diameter or cross-sectional area of a first part (141) of the channel (140),
the one or more adjustable members (130) are connected to the moveable brake element (170),
the moveable brake element (170) is moveable along the internal path (160) to alter a diameter or cross-sectional area of a second part (142) of the channel (140).

The invention further relates to the use a descent control device according to the invention to descend a person, user or load, and to a method of descending a person, user or load in which a descent control device according to the invention is used.

### FIELD OF THE INVENTION

The present invention relates to a descent control device. More specifically, the invention relates to a descent control device comprising rotatable and movable brake elements by which the degree of braking can be adjusted independently in relation to the desired rate of descent of a person, user, or load, and/or the weight of the person, user or load subject to descent.

### BACKGROUND OF THE INVENTION

Abseiling, also known as rappelling, is the controlled descent of a steep slope, such as a cliff face, by moving down a rope. In order to abseil down a cliff face, one end of a rope is made fast at the top of the cliff and the person making the descent then slides down the rope. The rope is passed either around the body of the person or, more usually, through a descent control device, also referred to as a descender, attached to a harness worn by the person such that the passage of the rope around the body or through the device provides sufficient friction to slow the rate of descent to a safe speed. Descent control devices are commonly used for vertical or sloped descent applications in sports, amusement, rescue services, emergency evacuation, and military operations, for example when quick extraction from a dangerous situation is vital. Descent control devices are also used in the workplace, e.g. by persons working at heights on roofs and buildings, and for persons to access difficult-to-reach areas from above for various industrial applications like maintenance, construction, inspection and welding.

A descent control device usually comprises a housing defining a path including a braking surface for a rope, a moveable control member pivotally connected to the housing and including a manually operable control handle protruding from the housing and a braking element co-operating with the braking surface to apply a braking force on the rope. In use, a harness of the user can be attached to the housing of the device so that a load is applied to the rope passing through the device. If the user does not operate the handle, the descent control device applies a braking force to the rope which will normally hold the user at a fixed position. In order to descend the rope, the user grips the handle against the housing of the device with a controlled force in order to reduce the degree of braking by a desired amount thus allowing the rope to slip though the device. To stop a descent, the user has to release the handle to apply the brake.

The user thus has the ability to adjust the braking force to the rope and thereby adjust or decelerate the rate of the descent. However, this is not possible with descending persons who are not in a condition to operate the descent control device themselves, e.g. children and persons who are unconscious, disabled, injured, terrified, panics and/or in medical shock.

A number of descent control devices have been developed to overcome such and related problems, e.g. EP 694317 A2 and WO 2016/131092. However, there are still disadvantages with the known devices and these may even lead to accidents. For example, the user or load may be stopped during the descent and may be hanging in the rope until the device is unlocked; the braking and stopping may be hard and sudden; the rope may be substantially weakened or damaged by the hard braking and either break in two parts immediately at the stop, or a short time after the stop with a maximum load, which may lead to a serious outcome as the user or load will fall freely to the ground; and the stop itself may hurt the user or load by the harness which attaches the user or load to the rope.

WO 2021/125967 discloses a descent control device comprising a housing, wherein the housing comprises a rope entrance (2) and a rope exit (3) located at opposite sides of the housing (1), a channel (5) having at least one curvature of at least 180 degrees, for accommodating the rope (4) internally in the housing, and an element (5) arranged in the centre of the curvature, limiting the inner radius of the channel. The element is eccentrically rotatable between a free position and a stop position, and provided with an arm (6) protruding out through the housing for controlling the rotating between the free position and the stop position. The channel in the curvature is more narrow along substantially its whole length when the element is in the stop position compared when the element is in the free position.

GB 2384182 discloses a self-contained emergency escape apparatus in which a pre-determined number of friction-based delay mechanisms with harness attachments are attached to an upper end of a rope. The friction-based delay mechanism manipulates the path of the rope to the extent that a person which is allowed to naturally fall will be slowed by the mechanism to a rate considerably less than that of gravity. The internal parts of the friction-based delay mechanism may be adjusted depending upon the rate of the descent required or the weight of the person. However, there is no disclosure of a smooth and simple adjustment of rotatable and movable brake elements allowing flexible adjustment of the degree of braking in relation to the desired rate of descent of a person, user, or load, and/or the weight of the person, user or load subject to descent.

It would be desirable to provide a descent control device which overcomes the disadvantages of previously known descent control devices. It would also be desirable to provide an improved descent control device comprising brake elements by which the degree of braking can be adjusted in a smooth and flexible manner in relation to the desired rate of descent of a person, user, or load, and/or the weight of the person, user or load subject to descent.

### SUMMARY OF THE INVENTION

It is an object of the present invention to provide a descent control device comprising rotatable and moveable brake elements by means of which the degree of braking can be adjusted independently in relation to the desired rate of descent of a person, user, or load, and/or the weight of the person, user or load subject to descent.

Accordingly, in one aspect, the present invention relates to a descent control device (100) comprising a housing (110), a moveable handle (120) protruding from the housing and one or more adjustable members (130) protruding from the housing, wherein the housing (110) comprises:
an entrance (111) and an exit (112) for a rope,
a channel (140) for a rope between the entrance and the exit,
a rotatable brake element (150),
an internal path (160), and
a moveable brake element (170),
   and wherein
the moveable handle (120) is connected to the rotatable brake element (150),
the rotatable brake element (150) is adjustable to alter a diameter or cross-sectional area of a first part (141) of the channel (140),
the one or more adjustable members (130) are connected to the moveable brake element (170),
the moveable brake element (170) is moveable along the internal path (160) to alter a diameter or cross-sectional area of a second part (142) of the channel (140).

In another aspect, the present invention relates to a device (100), e.g. a descent control device (100), comprising a housing (110), a moveable handle (120) protruding from the housing and one or more adjustable members (130) protruding from the housing, wherein the housing (110) comprises:
an entrance (111) and an exit (112), e.g. an entrance (111) and an exit (112) for a rope,
a channel (140) between the entrance and the exit, e.g. a channel (140) for a rope between the entrance and the exit,
a rotatable element (150), e.g. a rotatable brake element (150),
an internal path (160), and
a moveable element (170), e.g. a moveable brake element (170),
   and wherein
the moveable handle (120) is connected to the rotatable element (150), e.g. the rotatable brake element (150),
the rotatable element (150), e.g. the rotatable brake element (150), is adjustable to alter a diameter or cross-sectional area of a first part (141) of the channel (140),
the one or more adjustable members (130) are connected to the moveable element (170), e.g. the moveable brake element (170),
the moveable element (170), e.g. the moveable brake element (170), is moveable along the internal path (160) to alter a diameter or cross-sectional area of a second part (142) of the channel (140).

In another aspect, the present invention relates to the use of a descent control device, or a device, according to the invention for descending a person, user or load.

In yet another aspect, the present invention relates to a method of descending a person, user or load which comprises:
providing a descent control device, or a device, according to the invention;
providing a rope in the channel, whereby the rope extends from the entrance and the exit;
fastening or securing an end of the rope to a surrounding;
connecting a harness or the like to the descent control device and to the person, user or load;
moving the one or more adjustable members, which are protruding from the housing and connected to the moveable brake element, to move the moveable brake element along the internal path to alter the diameter or cross-sectional area of the second part of the channel; and
pulling the moveable handle connected to the rotatable brake element to increase the diameter or cross-sectional area of the second part of the channel, thereby allowing the rope run through the channel.

The descent control device according to the invention makes it possible to attain numerous advantages, including the following:
rotatable and movable brake elements, which can be adjusted independently of one another;
smooth and simple adjustment of the braking force on a rope, and smooth and simple adjustment of the friction applied to the rope, e.g. to increase or slow down the rate of descent, to a safe or desired speed;
opportunity to adjust the rate of descent, either before or during the descent, e.g. while descending the person, user or load;
the descent control device, or device, may be equipped with a scale linked to the braking force/friction applied to the rope, e.g. showing the rate of descent or weight of person, user or load;
opportunity to make a smooth and simple adjustment of the scale in relation to an estimated weight of the person, user or load subject to descent, e.g. to achieve a desired rate of descent;
simplified descent of persons who are not able to operate the descent control device themselves, e.g. children and persons who are unconscious, disabled, injured, terrified, panics and/or in medical shock;
simple maneuverability and improved flexibility of the descent control device during the descent which makes it possible for the user to have at least one hand, maybe two hands, free and available during the descent, thereby enabling the user to bring goods and/or support and secure a child or other person not able to operate a descent control device him/herself;
opportunity to avoid a hard brake at the descent, thereby reducing the risk of substantially weakening, damaging or breaking the rope by the descent;
easy to use and ability to fit the descent control device within the palm of the user's hand; and
enables very simple instruction or training of a user.

Hereby the present invention provides significant technical and safety benefits.

These and other objects and aspects of the invention will be described in further detail hereinafter.

### BRIEF DESCRIPTION OF THE DRAWINGS

The invention is described hereinafter, by way of example only, with reference to the accompanying drawings in which:

FIG. 1 is a front view of an embodiment of a descent control device, or device, according to the invention in a first orientation, the device being shown in an open or loading state;

FIG. 2 is front view of the embodiment of the descent control device, or device, of FIG. 1 but in which a moveable braking element is present in a different position;

FIG. 3 is a front view of an embodiment of a descent control device, or device, according to the invention in a second orientation, the device being shown in a closed or working state;

FIG. 4 is a side view of an embodiment of a descent control device, or device, according to the invention in a first orientation, the device being shown in an open or loading state; and

FIG. 5 is a schematic front view illustration of an embodiment of a descent control device, or device, according to the invention in a first orientation, the device being shown in an open or loading state.

### DESCRIPTION OF REFERENCE NUMBERS

The following reference numbers refer to the drawings:

| Reference | |
|---|---|
| Number | Component |
| 100 | Descent control device/Device |
| 110 | Housing |
| 111 | Entrance |
| 112 | Exit |
| 113 | Rope |
| 114 | Cover |
| 115 | Fastening means |
| 120 | Moveable handle |
| 130 | Adjustable member |
| 131 | Axis A |
| 140 | Channel between the entrance and the exit |
| 141 | First part of the channel |
| 142 | Second part of the channel |
| 150 | Rotatable brake element/Rotatable element |
| 151 | Axis R |
| 160 | Internal path |
| 161 | Non-parallel walls |
| 162 | Protruding locking element/Protruding element |
| 170 | Movable brake element/Movable element |
| 180 | Point of intersection |
| 190 | Scale |
| 200 | Element for fastening a harness or the like |

### DETAILED DESCRIPTION OF THE INVENTION

The present invention relates to a descent control device, or device, comprising rotatable and movable brake elements, by which the degree of braking of a rope can be independently adjusted in relation to the desired rate of descent of a person, user, or load, and/or the weight of the person, user or load subject to descent.

The terms “descent control device”, “device”, “descender”, “descendeur” and “controlled descend device”, as used herein, refers to a device that is suitable and/or intended for descending, abseiling or rappelling of a person, user or load; and are used interchangeably herein.

The descent control device, or device, according to the invention may be made by any suitable material. Examples of suitable materials include metallic materials and alloys, e.g. those made of or comprising one or more of aluminum, steel, stainless steel, and plastic materials.

The term “rope”, as used herein, refers to any sort of rope, including both static and flexible ropes, cable, cord or other elongate supporting means, suitable for use in and/or together with the descent control device of the invention. The rope has a diameter that may vary within wide limits, and usually the diameter is about 4 mm, or larger. Preferably, the rope has a rigidness preventing it from getting tangled or forming knots when coiled, and when passing through the descent control device. Examples of suitable ropes include braided ropes, such as a 12 strands braided rope, ropes of or comprising nylon, e.g. manufactured from Aramid®, Kevlar® or similar materials, ropes having a nylon core with a woven outer protective layer, etc.

The present invention and various embodiments thereof are described below with reference to the drawings, which are to be considered in all aspects as illustrative only and not restrictive in any manner. Elements illustrated in the drawings are not necessarily to scale, emphasis instead being placed upon clearly illustrating the principles of the invention. This invention may be provided in other specific forms and embodiments without departing from the essential characteristics described herein.

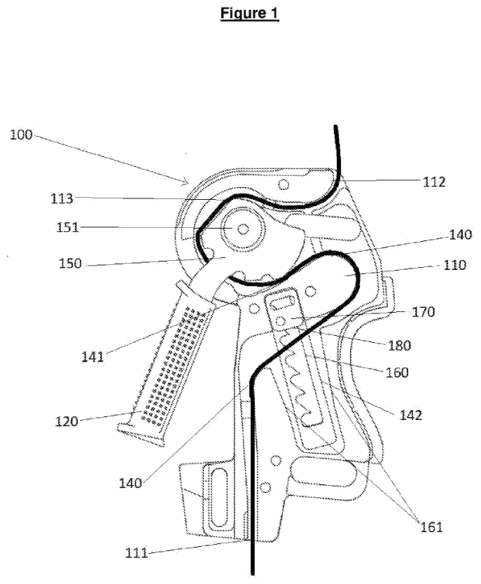

FIG. 1 is a front view of an embodiment of a descent control device (100) according to the invention. The descent control device is shown in a first orientation, in an open or loading state, or a state in which a cover of the housing (110) has been removed to better illustrate the components. The descent control device comprises a housing (110) and a moveable handle (120) protruding from the housing. The housing (110) comprises an entrance (111) and an exit (112) for a rope (113), a channel (140) for the rope (113) between the entrance (111) and the exit (112), a rotatable brake element (150), an internal path (160), and a moveable brake element (170). A moveable handle (120) is connected to the rotatable brake element (150) partly rotatable around an axis R (151) being part of the housing (110), and the rotatable brake element (150) is adjustable to alter a diameter or cross-sectional area of at least a first part (141) of the channel (140). The moveable brake element (170) is moveable along the internal path (160) to alter a diameter or cross-sectional area of at least a second part (142) of the channel (140). The moveable braking element (170) is present in the internal path (160) in a position to apply essentially no pressure or braking force on the rope (113). The channel (140) and the internal path (160) have a point of intersection (180). The internal path (160) has two non-parallel walls (161).

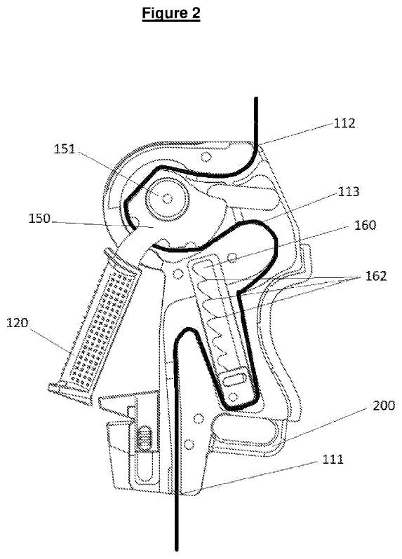

FIG. 2 is front view of an embodiment of the descent control device of FIG. 1 but in which the moveable braking element (170) is present in the internal path (160) in a different position to apply a significant pressure or braking force on the rope (113). FIG. 2 further shows a moveable handle (120) protruding from the housing and connected to the rotatable brake element (150), an entrance (111) and exit (112) for a rope (113), an internal path (160) comprising protruding locking elements (162), and an element (200) for fastening a harness or the like.

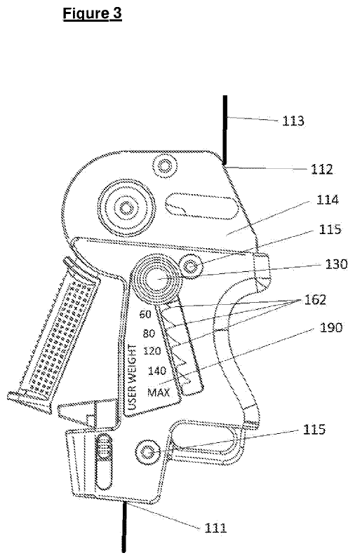

FIG. 3 is a front view of an embodiment of a descent control device according to the invention. The descent control device is shown in a second orientation, in a closed or working state, or a state which a cover (114) is attached to the housing by fastening means (115) in the form of bolts and nuts. FIG. 3 further shows an entrance (111) and exit (112) for a rope (113), an adjustable member (130) protruding from the housing, protruding locking elements (162), and a scale (190) related to weight, load and/or rate of descent.

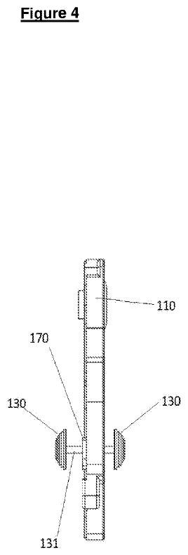

FIG. 4 is a side view of an embodiment of a descent control device according to the invention. The descent control device is shown in a first orientation, in an open or loading state. FIG. 4 further shows a housing (110), two adjustable members (130) protruding from the housing (110) and connected to the moveable brake element (170), and an axis A (131) connecting the two adjustable members (130).

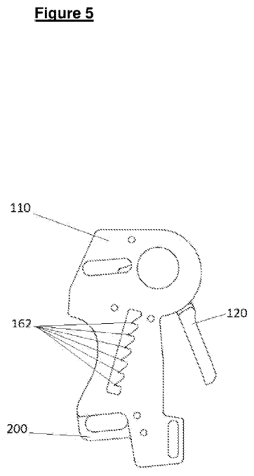

FIG. 5 is a schematic front view illustration of an embodiment of a descent control device according to the invention. The descent control device is shown in a first orientation, in an open or loading state. FIG. 5 further shows a housing (110), a moveable handle (120) protruding from the housing, protruding locking elements (162) present in the internal path, and an element (200) for fastening a harness or the like.

According to the invention, the channel (140) and the internal path (160) preferably have at least one point of intersection (180), usually a point of intersection (180). The point of intersection (180) is preferably adjustable by moving the moveable brake element (170) along the internal path (160).

According to the invention, the moveable brake element (170) is preferably moveable along the internal path (160) to alter a length of the channel (140). Further, the moveable brake element (170) is preferably moveable along the internal path (160) whereby the diameter or cross-sectional area of the second part (142) of the channel (140) is more reduced, or smaller, the longer is the channel (140).

According to the invention, the internal path (160) preferably has two non-parallel walls (161). Preferably, the two non-parallel walls (161) are at least partly wedge shaped, or substantially conical or V shaped. Preferably, the two non-parallel walls define an angle of at least 1 degree, preferably an angle from 1 to 25 degrees, or an angle from 2 to 20 degrees. Preferably, a distance between the two non-parallel walls (161) varies along the internal path (160). Preferably, the distance between the two non-parallel walls (161) is smaller the longer is the channel (140).

According to the invention, the channel (140) preferably comprises at least two adjustable braking surfaces for the rope (113) comprising at least first and second adjustable braking surfaces. The first part (141) of the channel (140) can be seen as the first adjustable braking surface, whereby the rotatable brake element (150) is adjustable to alter or adjust the first braking surface of the channel (140). The second part (142) of the channel (140) can be seen as the second adjustable braking surface, whereby the moveable brake element (170) is moveable along the internal path (160) to alter or adjust the second adjustable braking surface of the channel (140).

According to the invention, the internal path (160) preferably comprises one or more protruding locking elements (162), preferably a plurality of protruding locking elements. The number of protruding locking elements may be at least 2 and up to 15, usually from 3 to 10, or 4 to 7. Preferably, the internal path (160) allows locking of the moveable brake element (170) between two adjacent protruding locking elements. Preferably, the internal path (160) comprises protruding locking elements (162) connected to a scale (190) visible on an exterior surface of the cover (114) of the housing (110). Preferably, the internal path (160) allows locking of the moveable brake element (170) between two adjacent protruding locking elements whereby a reading of the scale (190) is altered when the moveable brake element (170) is locked between two other adjacent protruding locking elements. Preferably, the scale (190) is related to weight, load and/or rate of descent.

Preferably, the one or more adjustable members (130) comprise two adjustable members (130) which preferably are connected to the moveable brake element (170) by means of an axis A (131), preferably the two adjustable members (130) are protruding in different directions perpendicularly from the housing (110). Preferably, adjusting or moving the two adjustable members (130) allows locking of the axis A (131) and the moveable brake element (170) between two adjacent protruding locking elements.

According to the invention, the rotatable brake element (150) is preferably a partly rotatable brake element, preferably an eccentrically partly rotatable brake element. Preferably, the rotatable brake element (150) and the moveable brake element (170) are independently adjustable.

According to the invention, the channel (140) has at least one curvature of at least 180 degrees, or at least two curvatures of at least 180 degrees. Preferably, the channel (140) has at least one curvature of at least 270 degrees.

According to the invention, the descent control device comprises at least one element (200) for fastening a harness or the like.

According to the invention, the moveable handle (120) is preferably independently adjustable in relation to the one or more adjustable members (130) protruding from the housing, preferably manually independently adjustable.

According to the invention, the channel (140) preferably comprises a rope (113) which extends from the entrance (111) and the exit (112). Preferably, the rope has a diameter of at least 4 mm.

When using a descent control device (100) according to the invention, by pulling or releasing the moveable handle (120) connected to the rotatable brake element (150), it is possible to alter the diameter or cross-sectional area of the first part (141) of the channel (140), thus altering the first braking surface of the channel (140), thereby achieving a desired degree of braking and/or allowing the rope (113) to slip though the channel (140). To brake and/or stop a descent, the person or user may release the moveable handle (120), whereby the rotatable brake element (150) will rotate to a position to achieve a significant decrease of the diameter or cross-sectional area of the first part (141) of the channel (140), thereby applying a significant pressure, friction or braking force on the rope (113).

Prior to and/or when using a descent control device (100) according to the invention, by moving the one or more adjustable members (130) protruding from the housing, thereby moving the moveable brake element (170) along the internal path (160), and locking the moveable brake element (170) between two adjacent protruding locking elements, it is possible to alter the diameter or cross-sectional area of the second part (142) of the channel (140), thus altering the second braking surface of the channel (140), thereby achieving a desired degree of braking and/or allowing the rope (113) to slip though the channel (140). To change the speed of descent, the person or user may move the one or more adjustable members (130) and lock the moveable brake element (170) between two other adjacent protruding locking elements up or down the internal path (160), thereby decreasing or increasing the diameter or cross-sectional area of the second part (142) of the channel (140), and thus increasing or decreasing, respectively, the pressure, friction or braking force on the rope (113), whereby the speed will be lower or higher, respectively.

The descent control device according to the invention can be used in many applications. Examples of suitable uses according to the invention include vertical or sloped descent applications in sports, amusement, mountaineering, mountain climbing, canyoning, caving, tree felling, rescue services, emergency evacuation, military operations, workplace applications, e.g. for descending persons working at heights on roofs and buildings, industrial applications, e.g. for descending persons to access difficult-to-reach areas from above, e.g. for maintenance, construction, inspection and welding, and applications for descending a load.

The method of descending a person, user or load according to the invention comprises:
providing a descent control device according to the invention;
providing a rope in the channel, whereby the rope extends from the entrance and the exit;
fastening or securing an end of the rope to a surrounding;
connecting a harness or the like to the descent control device and to the person, user or load;
moving the one or more adjustable members, which are protruding from the housing and connected to the moveable brake element, to move the moveable brake element along the internal path to adjust the diameter or cross-sectional area of the second part of the channel; and
pulling the moveable handle connected to the rotatable brake element to increase the diameter or cross-sectional area of the second part of the channel, thereby allowing the rope run through the channel.

Preferably, the method comprises locking the moveable brake element between two adjacent protruding locking elements. Preferably, the method comprises moving the one or more adjustable members to move the moveable brake element along the internal path and lock the moveable brake element between two adjacent protruding locking elements. Preferably, a reading of the scale is altered when the moveable brake element is locked between two other adjacent protruding locking elements. Preferably, the scale is related to weight, load and/or rate of descent.

Preferably, the method comprises fastening or securing to a surrounding an end of the rope which extends from the exit. The method of the invention leads to simple maneuverability and improved flexibility of the descent control device during the descent, which makes it possible for the person or user to have at least one hand free and available during the descent, thereby enabling the person or user to carry a load and/or support and secure a child or other person not able to operate a descent control device him/herself.

Preferably, the method comprises moving the one or more adjustable members to move the moveable brake element along the internal path to adjust the diameter or cross-sectional area of the second part of the channel, thereby enabling the rope to run through the channel. By independently adjusting the moveable and rotatable brake elements, or by independently pulling the moveable handle connected to the rotatable brake element and moving the one or more adjustable members connected to the moveable brake element, a safe and/or desired speed of descent is obtainable.

Preferably, the method comprises pulling the moveable handle protruding from the housing towards the housing.

Preferably, the method comprises releasing the moveable handle connected to the rotatable brake element to decrease the diameter or cross-sectional area of the second part of the channel, thereby applying a significant pressure, friction or braking force on the rope, and optionally stopping the descent.

1. A descent control device (100) comprising a housing (110), a moveable handle (120) and one or more adjustable members (130) protruding from the housing, wherein the housing (110) comprises:
an entrance (111) and an exit (112) for a rope,
a channel (140) for a rope between the entrance (111) and the exit (112),
a rotatable brake element (150),
an internal path (160), and
a moveable brake element (170),
and wherein
the moveable handle (120) is connected to the rotatable brake element (150),
the rotatable brake element (150) is adjustable to alter a diameter or cross-sectional area of a first part (141) of the channel (140),
the one or more adjustable members (130) are connected to the moveable brake element (170),
the moveable brake element (170) is moveable along the internal path (160) to alter a diameter or cross-sectional area of a second part (142) of the channel (140).

2. The descent control device according to claim 1, wherein the channel (140) and the internal path (160) have at least one point of intersection (180).

3. The descent control device according to claim 1, wherein the channel (140) and the internal path (160) have a point of intersection (180), wherein the point of intersection (180) is adjustable by moving the moveable brake element (170) along the internal path (160).

4. The descent control device according to claim 1, wherein the moveable brake element (170) is moveable along the internal path (160) to alter a length of the channel (140).

5. The descent control device according to claim 1, wherein the moveable brake element (170) is moveable along the internal path (160) whereby the diameter or cross-sectional area of the second part (142) of the channel (140) is more reduced, or smaller, the longer is the channel (140).

6. The descent control device according to claim 1, wherein the internal path (160) has two non-parallel walls (161), preferably the two non-parallel walls (161) are at least partly wedge shaped, preferably the two non-parallel walls (161) define an angle of at least 1 degree, preferably an angle from 1 to 25 degrees, or an angle from 2 to 20 degrees.

7. The descent control device according to claim 1, wherein a distance between the two non-parallel walls (161) varies along the internal path (160), preferably the distance between the two non-parallel walls (161) is smaller the longer is the channel (140).

8. The descent control device according to claim 1, wherein the internal path (160) comprises one or more protruding locking elements (162), preferably a plurality of protruding locking elements, and preferably the internal path (160) allows locking of the moveable brake element (170) between two adjacent protruding locking elements.

9. The descent control device according to claim 1, wherein the internal path (160) comprises one or more protruding locking elements (162) connected to a scale (190) visible on an exterior surface of a cover (114) of the housing (110), preferably the internal path (160) allows locking of the moveable brake element (170) between two adjacent protruding locking elements.

10. The descent control device according to claim 1, wherein the rotatable brake element (150) is a partly rotatable brake element, preferably an eccentrically partly rotatable brake element.

11. The descent control device according to claim 1, wherein the channel (140) has at least one curvature of at least 180 degrees, or at least two curvatures of at least 180 degrees.

12. The descent control device according to claim 1, wherein the channel (140) has at least one curvature of at least 270 degrees.

13. The descent control device according to claim 1, wherein it comprises at least one element (200) for fastening a harness or the like.

14. The descent control device according to claim 1, wherein the rotatable brake element (150) and the moveable brake element (170) are independently adjustable.

15. The descent control device according to claim 1, wherein the moveable handle (120) is independently adjustable in relation to the one or more adjustable members (130) protruding from the housing, preferably manually independently adjustable.

16. The descent control device according to claim 1, wherein the channel (140) comprises a rope (113) which extends from the entrance (111) and the exit (112), preferably the rope has a diameter of at least 4 mm.

17. A method of descending a person, user or a load, the method comprising providing the descent control device according to claim 1 to the person, user or load and descending the person, user or load.

18. The method according to claim 17, wherein the descending is provided for vertical or sloped descent applications in a sport, amusement, mountaineering, mountain climbing, canyoning, caving, tree felling, a rescue service, emergency evacuation, a military operation, a workplace application, and descent applications of a load.

19. A method of descending a person, user or load which comprises:
providing a descent control device according to claim 1;
providing a rope in the channel, whereby the rope extends from the entrance and the exit;
fastening or securing to a surrounding an end of the rope which extends from the exit;
connecting a harness or the like to the descent control device and to the person, user or load;
moving the one or more adjustable members, which are protruding from the housing and connected to the moveable brake element, to move the moveable brake element along the internal path to alter the diameter or cross-sectional area of the second part of the channel; and
pulling the moveable handle connected to the rotatable brake element to increase the diameter or cross-sectional area of the second part of the channel, thereby allowing the rope run through the channel.

20. The method according to claim 19, further comprising locking the moveable brake element between two adjacent protruding locking elements.
